(19) United States
(12) Patent Application Publication
(10) Pub. No.: US 2020/0127312 A1
(43) Pub. Date: Apr. 23, 2020

(54) FUEL CELL SYSTEM, CONTROL METHOD THEREFOR, AND NON-TRANSITORY COMPUTER-READABLE STORAGE MEDIUM IN WHICH A PROGRAM IS STORED

(71) Applicant: HONDA MOTOR CO., LTD., Tokyo (JP)

(72) Inventors: Ryoji Sakai, Wako-shi (JP); Akihiro Matsui, Wako-shi (JP); Kuniaki Ojima, Wako-shi (JP)

(21) Appl. No.: 16/654,039

(22) Filed: Oct. 16, 2019

(30) Foreign Application Priority Data
Oct. 18, 2018 (JP) 2018-196798

(51) Int. Cl. H01M 8/04992; H01M 8/04089; H01M 8/0438; H01M 8/04746; H01M 8/0432; H01M 8/04223

(52) U.S. Cl. CPC H01M 8/04992; H01M 8/04089; H01M 8/04395; B60L 50/72; H01M 8/0432; H01M 8/04253; H01M 2220/20; H01M 8/04753

(57) ABSTRACT

A fuel cell system includes a fuel cell, an air pump which supplies air to the fuel cell, a passenger presence or absence determination unit which determines the presence or absence of a passenger in a vehicle in which the fuel cell and the air pump are installed, a discharge flow rate determination unit which determines a discharge flow rate of the air pump when the fuel cell is warmed up, in accordance with the presence or absence of the passenger in the vehicle, and a control unit which controls the air pump on the basis of the discharge flow rate determined by the discharge flow rate determination unit.

### CROSS-REFERENCE TO RELATED APPLICATION

This application is based upon and claims the benefit of priority from Japanese Patent Application No. 2018-196798 filed on Oct. 18, 2018, the contents of which are incorporated herein by reference.

### BACKGROUND OF THE INVENTION

### Field of the Invention

The present invention relates to a fuel cell system, a control method therefor, and a non-transitory computer-readable storage medium in which a program is stored.

### Description of the Related Art

Recently, fuel cell vehicles in which a fuel cell is used have attracted significant attention. The operating temperature of a fuel cell is relatively high. Therefore, at a time of starting the fuel cell, it is important for the fuel cell to be heated. Such a process is referred to as warming up the fuel cell. Further, warming up of the fuel cell is appropriately carried out in order to prevent malfunctioning caused by freezing of water that is generated inside the fuel cell.

In Japanese Laid-Open Patent Publication No. 2008-103250, a process such as the one discussed below is disclosed. More specifically, according to Japanese Laid-Open Patent Publication No. 2008-103250, a required output power of the fuel cell is calculated on the basis of sensor signals transmitted from an SOC sensor, a speed of rotation detecting sensor, and the like. Then, an output current command value is calculated on the basis of an IV characteristic map corresponding to the required output power of the fuel cell, and a minimum drive voltage of a traction motor. In addition, an air stoichiometric ratio is determined based on the output current command value, and the flow rate of an oxygen-containing gas is calculated on the basis of the air stoichiometric ratio.

### SUMMARY OF THE INVENTION

However, in the case that warming up of the fuel cell is simply performed in this manner, the noise and vibration from the air pump may cause discomfort to a user.

An object of the present invention is to provide a fuel cell system, a control method therefor, and a computer-readable non-transitory storage medium in which a program is stored, which are capable of performing a warm-up process while preventing any sense of discomfort from being imparted to the user.

A fuel cell system according to one aspect of the present invention comprises a fuel cell, an air pump configured to supply air to the fuel cell, a passenger presence or absence determination unit configured to determine presence or absence of a passenger in a vehicle in which the fuel cell and the air pump are installed, a discharge flow rate determination unit configured to determine a discharge flow rate of the air pump when the fuel cell is warmed up, in accordance with the presence or absence of the passenger in the vehicle, and a control unit configured to control the air pump on a basis of the discharge flow rate determined by the discharge flow rate determination unit.

A fuel cell system according to another aspect of the present invention comprises a fuel cell, an air pump configured to supply air to the fuel cell, a main switch determination unit configured to determine a state of a main switch in a vehicle in which the fuel cell and the air pump are installed, a temperature determination unit configured to determine whether or not a temperature detected by a temperature sensor provided in the vehicle is less than a threshold value, a discharge flow rate determination unit configured to determine a discharge flow rate of the air pump when the fuel cell is warmed up, on a basis of the temperature and the state of the main switch, and a control unit configured to control the discharge flow rate of the air pump on a basis of the discharge flow rate determined by the discharge flow rate determination unit.

In a control method for a fuel cell system according to yet another aspect of the present invention, including a fuel cell, and an air pump configured to supply air to the fuel cell, the control method comprises a step of determining presence or absence of a passenger in a vehicle in which the fuel cell and the air pump are installed, a step of determining a discharge flow rate of the air pump when the fuel cell is warmed up, in accordance with the presence or absence of the passenger in the vehicle, and a step of controlling the air pump on a basis of the discharge flow rate determined in the step of determining the discharge flow rate.

In a control method for a fuel cell system according to yet another aspect of the present invention, including a fuel cell, and an air pump configured to supply air to the fuel cell, the control method comprises a step of determining a state of a main switch in a vehicle in which the fuel cell and the air pump are installed, a step of determining whether or not a temperature detected by a temperature sensor provided in the vehicle is less than a threshold value, a step of determining a discharge flow rate of the air pump when the fuel cell is warmed up, on a basis of the temperature and the state of the main switch, and a step of controlling the discharge flow rate of the air pump on a basis of the discharge flow rate determined in the step of determining the discharge flow rate.

In a non-transitory computer-readable storage medium in which a program is stored according to yet another aspect of the present invention, a computer is provided in a fuel cell system that includes a fuel cell and an air pump configured to supply air to the fuel cell. The program serves to execute in the computer a step of determining the presence or absence of a passenger in a vehicle in which the fuel cell and the air pump are installed, a step of determining a discharge flow rate of the air pump when the fuel cell is warmed up, in accordance with the presence or absence of the passenger in the vehicle, and a step of controlling the air pump on a basis of the discharge flow rate determined in the step of determining the discharge flow rate.

In a non-transitory computer-readable storage medium in which a program is stored according to yet another aspect of the present invention, a computer is provided in a fuel cell system that includes a fuel cell and an air pump configured to supply air to the fuel cell. The program serves to execute in the computer a step of determining a state of a main switch in a vehicle in which the fuel cell and the air pump are installed, a step of determining whether or not a temperature detected by a temperature sensor provided in the vehicle is less than a threshold value, a step of determining a discharge flow rate of the air pump when the fuel cell is warmed up, on a basis of the temperature and the state of the main switch, and a step of controlling the discharge flow rate of the air pump on a basis of the discharge flow rate determined in the step of determining the discharge flow rate.

According to the present invention, it is possible to provide the fuel cell system, the control method therefor, and the computer-readable non-transitory storage medium in which a program is stored, which are capable of performing a warm-up process while preventing any sense of discomfort from being imparted to the user.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a block diagram showing a vehicle equipped with a fuel cell system according to a first embodiment of the present invention;

FIG. 2 is a flowchart showing operations of the fuel cell system according to the first embodiment.

FIG. 3 is a time chart showing an example of operations of the fuel cell system according to the first embodiment;

FIG. 4 is a block diagram showing a vehicle equipped with a fuel cell system according to a second embodiment of the present invention;

FIG. 5 is a flowchart showing operations of the fuel cell system according to the second embodiment; and

FIG. 6 is a time chart showing an example of operations of the fuel cell system according to the second embodiment.

### DESCRIPTION OF THE PREFERRED EMBODIMENTS

Preferred embodiments of a fuel cell system according to the present invention, a control method therefor, and a computer-readable non-transitory storage medium in which a program is stored will be presented and described in detail below with reference to the accompanying drawings.

### First Embodiment

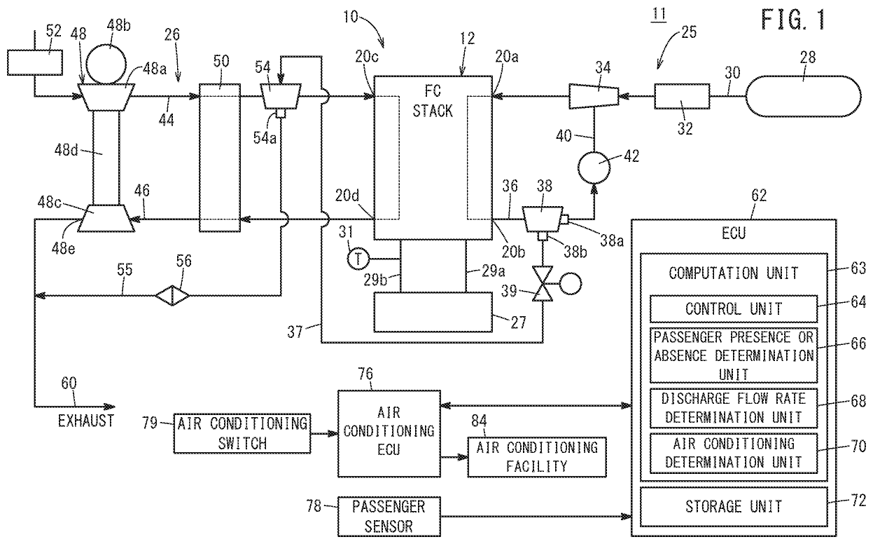

A description will be given with reference to the drawings concerning a fuel cell system according to a first embodiment of the present invention, a control method therefor, and a computer-readable non-transitory storage medium in which a program is stored. FIG. 1 is a block diagram showing a vehicle equipped with the fuel cell system according to the present embodiment.

As shown in FIG. 1, a vehicle 11 is equipped with a fuel cell system 10 according to the present embodiment. The vehicle 11 is a fuel cell vehicle, and more specifically, is a fuel cell electric vehicle. On the vehicle 11, there is provided an exhaust pipe 60, which discharges to the exterior of the vehicle 11 a cathode exhaust gas that flows out from the fuel cell system 10.

The vehicle 11 is further equipped with an ECU (Electronic Control Unit) 62, which administers the control of the fuel cell system 10 as a whole, together with carrying out predetermined processes. In the vehicle 11, there are further provided an air conditioning facility (air conditioner) 84 and an air conditioning ECU 76 that controls the air conditioning facility 84. The air conditioning facility 84 is operated by electric power that is supplied from the fuel cell system 10. The air conditioning facility 84 can be turned on or off, for example, by an air conditioning switch 79 being operated by the user. The vehicle 11 is further equipped with a drive ECU and a brake ECU, although such features are not shown herein.

The vehicle 11 is equipped with a passenger sensor 78 which detects the presence or absence of a passenger (user) inside the vehicle 11. Moreover, the vehicle 11 is equipped with other constituent elements apart from the constituent elements noted above. However, description of such elements is omitted herein.

A computation unit 63 and a storage unit 72 are provided in the ECU 62. The computation unit 63 can be constituted, for example, by a CPU (Central Processing Unit). The computation unit 63 serves to control each of respective units of the fuel cell system 10 on the basis of programs that are stored in the storage unit 72. The computation unit 63 comprises a control unit 64, a passenger presence or absence determination unit 66, a discharge flow rate determination unit 68, and an air conditioning determination unit 70. Based on a signal supplied from the passenger sensor 78, the passenger presence or absence determination unit 66 determines the presence or absence of a passenger in the vehicle 11. The discharge flow rate determination unit 68 determines the discharge flow rate of an air pump 48 when a fuel cell stack 12 is warmed up, in accordance with the presence or absence of the passenger in the vehicle 11. In the case that a passenger is present in the vehicle 11, the discharge flow rate determination unit 68 determines that the discharge flow rate of the air pump 48 is a first flow rate. In the case that a passenger is not present in the vehicle 11, the discharge flow rate determination unit 68 determines that the discharge flow rate of the air pump 48 is a second flow rate which is larger than the first flow rate. The air conditioning determination unit 70 determines whether or not the air conditioning facility 84 is in an ON state. The control unit 64 controls the air pump 48 based on the discharge flow rate determined by the discharge flow rate determination unit 68. The control unit 64, the passenger presence or absence determination unit 66, the discharge flow rate determination unit 68, and the air conditioning determination unit 70 can be realized by programs which are stored in the storage unit 72 being executed by the computation unit 63.

The fuel cell system 10 comprises a fuel cell stack (FC STACK, fuel cell) 12 which performs generation of power using a fuel gas and an oxygen-containing gas. The fuel cell system 10 is equipped with a fuel gas supply device 25 that supplies a fuel gas (for example, hydrogen gas) to the fuel cell stack 12, and an oxygen-containing gas supply device 26 that supplies air, which is an oxygen-containing gas, to the fuel cell stack 12. In the fuel cell system 10, there is further provided a non-illustrated battery serving as an energy storage device. The fuel cell stack 12 is further equipped with a coolant supply device 27 that supplies a coolant to the fuel cell stack 12.

The fuel cell stack 12 is constituted by stacking a plurality of non-illustrated power generation cells. Each of the power generation cells is constituted by sandwiching a membrane electrode assembly (MEA) between separators. Such a membrane electrode assembly is constituted by disposing an anode on one surface of an electrolyte membrane, and disposing a cathode on another surface of the electrolyte membrane. As the electrolyte membrane, for example, a polymer ion exchange membrane is used. Generation of electrical power is carried out by supplying a fuel gas containing hydrogen to the anodes, and supplying an oxygen-containing gas containing oxygen to the cathodes.

The fuel gas supply device 25 includes a fuel gas tank 28 that stores a high pressure fuel gas (high-pressure hydrogen), a fuel gas supply line 30 that guides the fuel gas to the fuel cell stack 12, and an injector 32 disposed in the fuel gas supply line 30. The fuel gas supply device 25 further includes an ejector 34 provided on a downstream side of the injector 32. The fuel gas supply line 30 is connected to a fuel gas inlet port 20a of the fuel cell stack 12. A fuel gas injection device is constituted by the injector 32 and the ejector 34.

A fuel gas discharge line 36 is connected to a fuel gas outlet port 20b of the fuel cell stack 12. The fuel gas discharge line 36 directs an anode exhaust gas (fuel off gas), which is a fuel gas that has been at least partially used in the anodes of the fuel cell stack 12, outwardly from the fuel cell stack 12. A circulation line 40 is connected to the fuel gas discharge line 36. The circulation line 40 guides the anode exhaust gas to the ejector 34. A hydrogen pump 42 (circulation pump) is disposed in the circulation line 40. It should be noted that the hydrogen pump 42 need not necessarily be provided.

A gas-liquid separator 38 is disposed in the fuel gas discharge line 36. A connection line 37 is connected to a liquid discharge port 38b of the gas-liquid separator 38. A drain valve 39, which is controlled to be opened and closed by the control unit 64, is provided in the connection line 37.

The oxygen-containing gas supply device 26 includes an oxygen-containing gas supply line 44 connected to an oxygen-containing gas inlet port 20c of the fuel cell stack 12, and an oxygen-containing gas discharge line 46 connected to an oxygen-containing gas outlet port 20d of the fuel cell stack 12. The oxygen-containing gas supply device 26 further includes the air pump 48 that supplies air toward the fuel cell stack 12, and a humidifier 50 that humidifies the air supplied to the fuel cell stack 12.

The air pump 48 includes a compressor 48a that compresses air, a motor 48b that rotatably drives the compressor 48a, and an expander 48c (regenerating mechanism) coupled to the compressor 48a. The air pump 48 is controlled by the control unit 64. The compressor 48a is disposed in the oxygen-containing gas supply line 44. In the oxygen-containing gas supply line 44, an air cleaner 52 is disposed on a more upstream side than the compressor 48a. Air is introduced into the compressor 48a through the air cleaner 52.

The expander 48c is disposed in the oxygen-containing gas discharge line 46. An impeller of the expander 48c is connected via a connecting shaft 48d to an impeller of the compressor 48a. The impeller of the compressor 48a, the connecting shaft 48d, and the impeller of the expander 48c rotate integrally about an axis of rotation (not shown). The cathode exhaust gas is introduced into the impeller of the expander 48c, and fluid energy is regenerated from the cathode exhaust gas. The regenerative energy covers a portion of the driving force for rotating the compressor 48a.

The humidifier 50 includes a large number of hollow fiber membranes through which moisture can permeate. By way of such hollow fiber membranes, moisture is exchanged between the air directed toward the fuel cell stack 12, and the high humidity cathode exhaust gas discharged from the fuel cell stack 12. In this manner, the air directed toward the fuel cell stack 12 is humidified.

In the oxygen-containing gas supply line 44, a gas-liquid separator 54 is disposed between the humidifier 50 and the oxygen-containing gas inlet port 20c of the fuel cell stack 12. The connection line 37 is connected to the gas-liquid separator 54. One end of a drain pipe 55 is connected to a liquid discharge port 54a of the gas-liquid separator 54. Another end of the drain pipe 55 is connected to the exhaust pipe 60. An orifice 56 is disposed in the drain pipe 55. It should be noted that the gas-liquid separator 54 need not necessarily be provided. In the case that the gas-liquid separator 54 is not provided, the connection line 37 may be directly connected to the oxygen-containing gas supply line 44.

The exhaust pipe 60 is connected to an outlet port 48e of the expander 48c. The exhaust pipe 60 extends from the outlet port 48e of the expander 48c, and extends to a rear part of the vehicle body along the bottom of the vehicle body (not shown).

The coolant supply device 27 supplies a coolant to the fuel cell stack 12 via a pipe 29a. The coolant that is supplied to the fuel cell stack 12 is returned to the coolant supply device 27 via a pipe 29b. A temperature sensor 31 is provided in the pipe 29b. The temperature sensor 31 is capable of detecting the temperature of the fuel cell stack 12.

The passenger sensor 78 detects the presence or absence of a passenger in the interior of the vehicle 11, and supplies a signal indicating the presence or absence of the passenger to the ECU 62.

At a time of normal operation, the fuel cell system 10 operates in the following manner. More specifically, in the fuel gas supply device 25, the fuel gas is supplied from the fuel gas tank 28 to the fuel gas supply line 30. At this time, the fuel gas is injected by the injector 32 toward the ejector 34, and via the ejector 34, is introduced from the fuel gas inlet port 20a into a fuel gas flow passage inside the fuel cell stack 12, and is supplied to the anodes.

On the other hand, in the oxygen-containing gas supply device 26, the air pump 48 (compressor 48a) is rotated, and air which forms the oxygen-containing gas is delivered to the oxygen-containing gas supply line 44. After being humidified by the humidifier 50, the air is introduced from the oxygen-containing gas inlet port 20c into an oxygen-containing gas flow passage inside the fuel cell stack 12, and is supplied to the cathodes. In each of the power generation cells, the fuel gas supplied to the anodes, and the oxygen contained within the air supplied to the cathodes are partially consumed by electrochemical reactions within the electrode catalyst layers, whereby generation of electrical power is carried out.

Fuel gas that has not been consumed at the anodes is discharged from the fuel gas outlet port 20b into the fuel gas discharge line 36 as an anode exhaust gas. Liquid water discharged from the anodes is introduced into the gas-liquid separator 38 together with the anode exhaust gas. The anode exhaust gas is separated from the liquid water by the gas-liquid separator 38, and the anode exhaust gas flows into the circulation line 40 via a gas discharge port 38a of the gas-liquid separator 38. Based on an instruction from the control unit 64, the amount of liquid within the gas-liquid separator 38 is adjusted by opening or closing the drain valve 39. Moreover, when operation of the fuel cell stack 12 is stopped, the drain valve 39 is opened, and the liquid water within the gas-liquid separator 38 is discharged by gravity through the connection line 37 into the gas-liquid separator 54 that is provided in the oxygen-containing gas supply line 44. The liquid water is discharged from the gas-liquid separator 54 to the exterior of the vehicle via the drain pipe 55 and the exhaust pipe 60.

The anode exhaust gas is introduced into the ejector 34 from the fuel gas discharge line 36 via the circulation line 40. The anode exhaust gas introduced into the ejector 34 is mixed with the fuel gas that is injected by the injector 32, and the mixed gas is supplied to the fuel cell stack 12.

From the oxygen-containing gas outlet port 20d of the fuel cell stack 12, a humidified cathode exhaust gas, which contains oxygen that has not been consumed at the cathodes, and water, which is a reaction product produced at the cathodes, are discharged into the oxygen-containing gas discharge line 46. After exchange of moisture with the air directed toward the fuel cell stack 12 is carried out in the humidifier 50, the cathode exhaust gas is introduced into the expander 48c of the air pump 48. In the expander 48c, recovery (regeneration) of energy from the cathode exhaust gas is carried out, and the regenerative energy becomes a portion of the driving force for the compressor 48a. The cathode exhaust gas and water are discharged from the expander 48c into the exhaust pipe 60, and are released to the exterior of the vehicle through the exhaust pipe 60.

When operation of the fuel cell system 10 is initiated, in the case that the control unit 64 determines that warming up of the fuel cell stack 12 is necessary, the warm-up operation (warm-up process) is performed prior to the normal operation. For example, the control unit 64 is capable of determining whether or not warming up of the fuel cell stack 12 is necessary, on the basis of the temperature of the fuel cell stack 12 that is detected using the temperature sensor 31. During the warm-up operation, by an instruction from the control unit 64, the drain valve 39 provided in the connection line 37 that is connected to the gas-liquid separator 38 is opened. In addition, in the same manner as in the normal operation, the fuel gas is supplied to the anodes of the fuel cell stack 12 by the fuel gas supply device 25, together with the oxygen-containing gas being supplied to the cathodes of the fuel cell stack 12 by the oxygen-containing gas supply device 26, whereby generation of electrical power is carried out.

Since the drain valve 39 is opened, the fuel gas is introduced into the oxygen-containing gas supply line 44 via the connection line 37. Therefore, the fuel gas is supplied together with the oxygen-containing gas to the cathodes of the fuel cell stack 12. As a result, by the oxygen-containing gas and the fuel gas, an exothermic reaction (catalytic combustion) is generated at the cathode catalyst. The fuel cell stack 12 is rapidly heated by heat accompanying the exothermic reaction, and by heat accompanying the generation of power. In addition, in the case it is determined that a warm-up completion temperature has been reached, the drain valve 39 is closed, and the process transitions to the above-described normal operation.

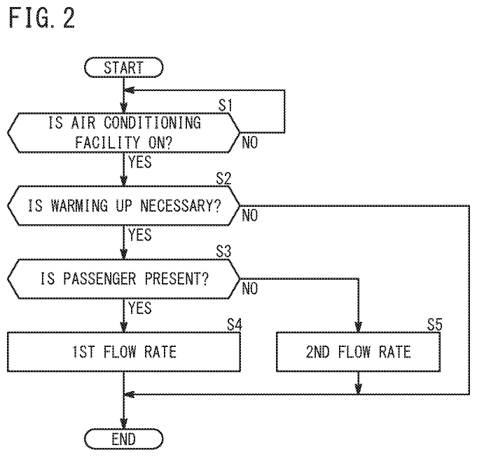

Operations of the fuel cell system according to the present embodiment will be described with reference to FIG. 2. FIG. 2 is a flowchart showing operations of the fuel cell system according to the present embodiment.

In step S1, on the basis of a signal supplied from the air conditioning ECU 76, the air conditioning determination unit 70 determines whether or not the air conditioning facility 84 is in the ON state. The air conditioning facility 84 can be turned on or off, for example, by the air conditioning switch 79 being operated by the user. In the case that the air conditioning facility 84 is in the ON state, the process transitions to step S2. In the case that the air conditioning facility 84 is in the OFF state, then after a predetermined time period has elapsed, step S1 is executed again.

In step S2, based on the temperature detected by the temperature sensor 31, the control unit 64 determines whether or not it is necessary for the fuel cell stack 12 to be warmed up. In the case that the temperature detected by the temperature sensor 31 is less than a predetermined temperature, the control unit 64 determines that warming up of the fuel cell stack 12 is necessary. In this case, the process transitions to step S3. In the case that the temperature detected by the temperature sensor 31 is greater than or equal to the predetermined temperature, the control unit 64 determines that warming up of the fuel cell stack 12 is not necessary. In this case, the process shown in FIG. 2 is brought to an end. In this case, normal operation of the fuel cell stack 12 is implemented.

In step S3, based on a signal supplied from the passenger sensor 78, the passenger presence or absence determination unit 66 determines the presence or absence of a passenger in the vehicle 11. In the case that a passenger is present in the vehicle 11, the process transitions to step S4. In the case that a passenger is not present in the vehicle 11, the process transitions to step S5.

In step S4, the discharge flow rate determination unit 68 determines that the discharge flow rate in the air pump 48 is the first flow rate. The control unit 64 controls the air pump 48 based on the discharge flow rate determined by the discharge flow rate determination unit 68. In this case, the discharge flow rate in the air pump 48 is set to the first flow rate. The first flow rate is a relatively small flow rate. Since the discharge flow rate of the air pump 48 is relatively small, vibration and noise caused by the air pump 48 are relatively small. For this reason, it is possible to prevent any sense of discomfort from being imparted to the passenger inside the vehicle 11.

In step S5, the discharge flow rate determination unit 68 determines that the discharge flow rate in the air pump 48 is the second flow rate which is larger than the first flow rate. The control unit 64 controls the air pump 48 based on the discharge flow rate determined by the discharge flow rate determination unit 68. In this case, the discharge flow rate in the air pump 48 is set to the second flow rate. The second flow rate is a relatively large flow rate. Since the discharge flow rate of the air pump 48 is relatively large, vibration and noise caused by the air pump 48 are relatively large. However, since there is no passenger in the vehicle 11, no sense of discomfort is imparted to the passenger.

By preforming the steps described above, the fuel cell system 10 according to the present embodiment is driven.

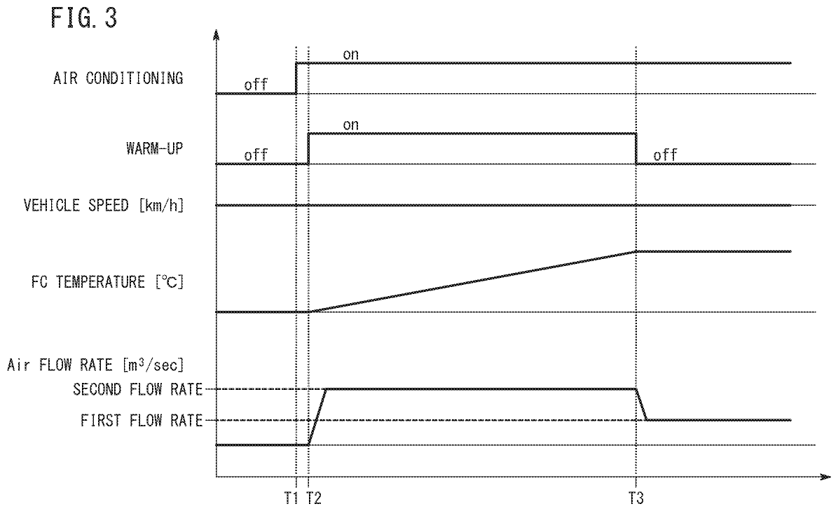

FIG. 3 is a time chart showing an example of operations of the fuel cell system according to the present embodiment. In this instance, an exemplary case is illustrated in which air conditioning using the air conditioning facility 84 is performed before traveling of the vehicle 11 is initiated.

At timing T1, the air conditioning facility 84 is set to the ON state. On a basis of a signal supplied from the air conditioning ECU 76, the air conditioning determination unit 70 determines that the air conditioning facility 84 has been placed in the ON state.

At timing T2, the warm-up operation of the fuel cell stack 12 is initiated. In the case that a passenger is present in the vehicle 11, the discharge flow rate of the air pump 48, i.e., the air flow rate, is set to the first flow rate which is a relatively small flow rate. Since the discharge flow rate of the air pump 48 is relatively small, vibration and noise caused by the air pump 48 are relatively small. For this reason, it is possible to prevent any sense of discomfort from being imparted to the passenger. On the other hand, in the case that a passenger is not present in the vehicle 11, the discharge flow rate of the air pump 48 is set to the second flow rate which is larger than the first flow rate. Since the discharge flow rate of the air pump 48 is relatively large, although vibration and noise caused by the air pump 48 become relatively large, since there is no passenger in the vehicle 11, no sense of discomfort is imparted to the passenger. Since the warm-up operation is started at timing T2, the temperature of the fuel cell stack 12, i.e., the FC temperature, begins to rise. Since traveling of the vehicle 11 has not yet been initiated, the speed of the vehicle 11 is 0 km/h.

At timing T3, the warm-up operation is brought to an end, and the system transitions to normal operation. During normal operation, the discharge flow rate of the air pump 48 is set to a flow rate that is smaller than the second flow rate. In this instance, an exemplary case will be described in which the discharge flow rate of the air pump 48 during the normal operation is set to the first flow rate. However, the present invention is not limited to this feature.

In the foregoing manner, according to the present embodiment, when the fuel cell stack 12 is warmed up, the discharge flow rate of the air pump 48 is determined in accordance with the presence or absence of a passenger in the vehicle 11. In the case that warming up is carried out in a state with a passenger not being present inside the vehicle 11, the discharge flow rate of the air pump 48 can be set relatively large. When the discharge flow rate of the air pump 48 is set relatively large, although vibration and noise caused by the air pump 48 become relatively large, since there is no passenger in the vehicle 11, no sense of discomfort is imparted to the passenger. On the other hand, in the case that warming up is carried out in a state with a passenger being present in the vehicle 11, the discharge flow rate of the air pump 48 can be set relatively small. Since the discharge flow rate of the air pump 48 is relatively small, vibration and noise caused by the air pump 48 are relatively small, and it is possible to prevent any sense of discomfort from being imparted to the passenger.

### Second Embodiment

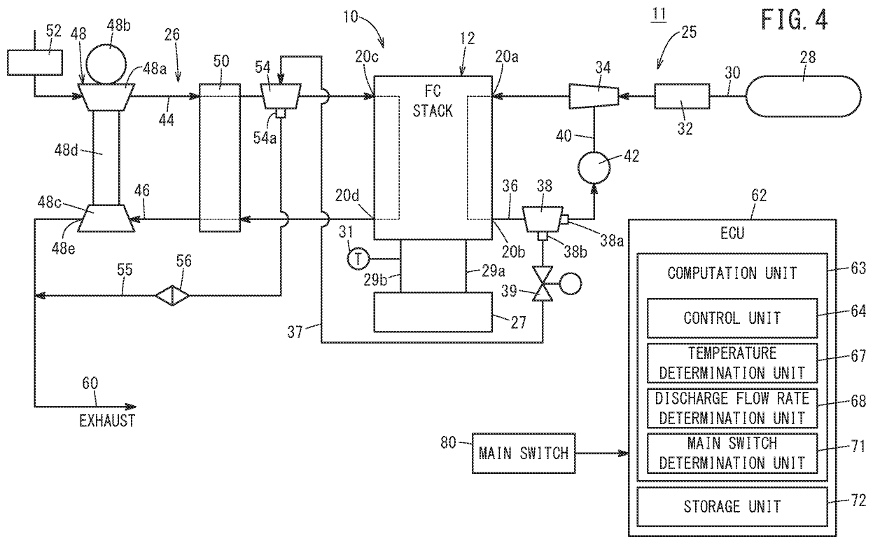

A description will be given with reference to the drawings concerning a fuel cell system according to a second embodiment of the present invention, a control method therefor, and a computer-readable non-transitory storage medium in which a program is stored. FIG. 4 is a block diagram showing a vehicle equipped with the fuel cell system according to the present embodiment. The same constituent elements as those of the fuel cell system according to the first embodiment are denoted by the same reference numerals, and description of such features is either omitted or simplified.

According to the present embodiment, the control unit 64, a temperature determination unit 67, the discharge flow rate determination unit 68, and a main switch determination unit 71 are provided in the computation unit 63. The temperature determination unit 67 determines whether or not the temperature detected by the temperature sensor 31 is less than a threshold value. The threshold value can be a freezing point, for example. However, the threshold value is not limited to such a point. On the basis of a signal supplied from a main switch (ignition switch) 80, the main switch determination unit 71 determines whether or not the main switch 80 is in an ON state. The control unit 64, the temperature determination unit 67, the discharge flow rate determination unit 68, and the main switch determination unit 71 can be realized by programs which are stored in the storage unit 72 being executed by the computation unit 63. Moreover, in this instance, an exemplary case has been described in which the temperature determination unit 67 determines whether or not the temperature detected by the temperature sensor 31 that detects the temperature of the fuel cell stack 12 is less than the threshold value. However, the present invention is not limited to this feature. The temperature determination unit 67 may determine whether or not the temperature detected by a temperature sensor, which is provided in any arbitrary location of the vehicle 11, is less than the threshold value.

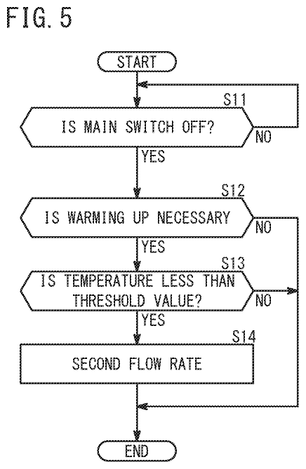

Operations of the fuel cell system according to the present embodiment will be described with reference to FIG. 5. FIG. 5 is a flowchart showing operations of the fuel cell system according to the present embodiment.

In step S11, based on a signal supplied from the main switch 80, the main switch determination unit 71 determines whether or not the main switch 80 is in an ON state. Turning the main switch 80 on or off can be carried out, for example, by the main switch 80 being operated by the user. In the case that the main switch 80 is in an OFF state (YES in step S11), the process transitions to step S12. In the case that the main switch 80 is in the ON state (NO in step S11), then after a predetermined time period has elapsed, step S11 is executed again.

In step S12, the control unit 64 determines whether or not it is necessary to perform a warm-up operation for the purpose of removing water generated inside the fuel cell stack 12 from the interior of the fuel cell stack 12. The warm-up operation for the purpose of removing water generated inside the fuel cell stack 12 from the interior of the fuel cell stack 12 is performed in order to prevent problems or malfunctioning caused by freezing of the water generated inside the fuel cell stack 12. For example, in the case that the warm-up operation for the purpose of removing water generated in the fuel cell stack 12 from the interior of the fuel cell stack 12 has not yet been performed, the control unit 64 determines that warming up of the fuel cell stack 12 is necessary. In this case, the process transitions to step S13. For example, in the case that the warm-up operation for the purpose of removing water generated in the fuel cell stack 12 from the interior of the fuel cell stack 12 has already been performed, the control unit 64 determines that warming up of the fuel cell stack 12 is not necessary. In this case, the process shown in FIG. 5 is brought to an end.

In step S13, the temperature determination unit 67 determines whether or not the temperature detected by the temperature sensor 31 is less than a threshold value. In the case that the temperature detected by the temperature sensor 31 is less than the threshold value, the process proceeds to step S14. In the case that the temperature detected by the temperature sensor 31 is greater than or equal to the threshold value, the process shown in FIG. 5 is brought to an end.

In step S14, the discharge flow rate determination unit 68 determines that the discharge flow rate in the air pump 48 is the second flow rate. The second flow rate is larger than the first flow rate, which is the discharge flow rate of the air pump 48 when the fuel cell stack 12 is warmed up, without the vehicle 11 being made to travel in a state with the main switch 80 being turned on. More specifically, the second flow rate is larger than the first flow rate, which is the discharge flow rate of the air pump 48 during normal operation. The control unit 64 controls the air pump 48 based on the discharge flow rate determined by the discharge flow rate determination unit 68. In this case, the discharge flow rate in the air pump 48 is set to the second flow rate.

By preforming the steps described above, the fuel cell system 10 according to the present embodiment is driven.

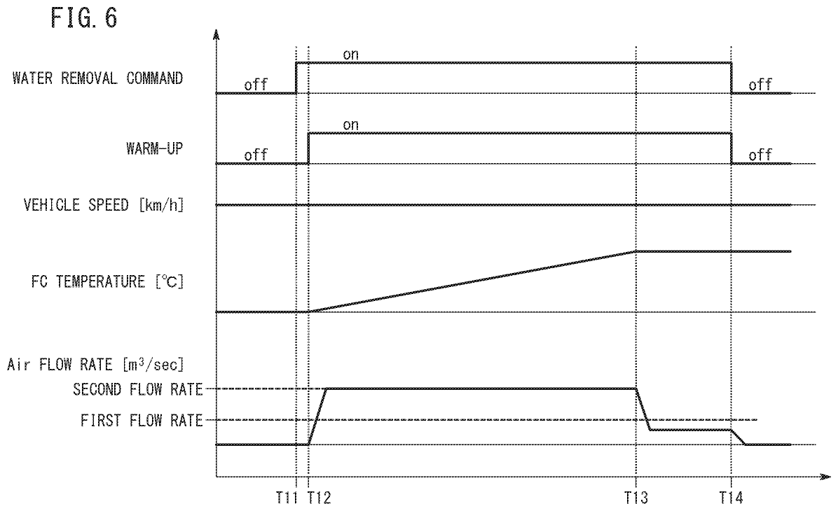

FIG. 6 is a time chart showing an example of operations of the fuel cell system according to the present embodiment. In this instance, an exemplary case is illustrated in which a warm-up operation is performed for the purpose of removing water that is generated inside the fuel cell stack 12. The warm-up operation for the purpose of removing water generated inside the fuel cell stack 12 can be performed in the case that the main switch 80 is turned off, and the temperature detected by the temperature sensor 31 is less than a threshold value.

At timing T11, the control unit 64 outputs a command, i.e., a water removal command, for removing the water that is generated inside the fuel cell stack 12.

At timing T12, the warm-up operation of the fuel cell stack 12 is initiated. The discharge flow rate, or in other words, the air flow rate of the air pump 48 is set to the second flow rate which is a relatively large flow rate. Since the discharge flow rate of the air pump 48 is relatively large, vibration and noise caused by the air pump 48 are relatively large. However, since the main switch 80 is in the OFF state, while in addition the temperature detected by the temperature sensor 31 is also less than the threshold value, it is considered that a passenger is not present in the vehicle 11. For this reason, no sense of discomfort is imparted to the passenger. Since the warm-up operation is started at timing T12, the temperature of the fuel cell stack 12, i.e., the FC temperature, begins to rise. Since traveling of the vehicle 11 has not yet been initiated, the speed of the vehicle 11 is 0 km/h.

After timing T13, the discharge flow rate of the air pump 48 is set to a third flow rate which is smaller than the second flow rate. When the discharge flow rate of the air pump 48 is set to the third flow rate, the temperature of the fuel cell stack 12 is maintained at a constant temperature.

At timing T14, the warm-up operation is brought to an end. After timing T14, the discharge flow rate of the air pump 48 is set to 0 m³/sec, for example.

In the foregoing manner, according to the present embodiment, in the case that the temperature detected by the temperature sensor 31 provided in the vehicle 11 is less than the threshold value, and warming up is performed in a state with the main switch 80 being turned off, the following situation is brought about. More specifically, in such a case, the discharge flow rate of the air pump 48 can be set relatively large. When the discharge flow rate of the air pump 48 is set relatively large, vibration and noise caused by the air pump 48 become relatively large. However, in the case that the temperature detected by the temperature sensor 31 provided in the vehicle 11 is less than the threshold value, and the main switch 80 is turned off, it is considered that a passenger is not present in the vehicle 11. Therefore, according to the present embodiment, it is possible to prevent any sense of discomfort from being imparted to the passenger.

### Modified Embodiments

Although preferred embodiments of the present invention have been described above, the present invention is not limited to the above-described embodiments, and various modifications can be made thereto without departing from the essence and scope of the present invention.

For example, according to the above-described embodiment, although an exemplary case has been described in which the warm-up operation is carried out by opening the drain valve 39 provided in the connection line 37, the present invention is not limited to this feature. The present invention can also be applied to various fuel cell systems in which performance of a warm-up operation is required.

The above embodiments can be summarized in the following manner.

The fuel cell system (10) includes the fuel cell (12), the air pump (48) configured to supply air to the fuel cell, the passenger presence or absence determination unit (66) configured to determine the presence or absence of the passenger in the vehicle (11) in which the fuel cell and the air pump are installed, the discharge flow rate determination unit (68) configured to determine the discharge flow rate of the air pump when the fuel cell is warmed up, in accordance with the presence or absence of the passenger in the vehicle, and the control unit (64) configured to control the air pump on the basis of the discharge flow rate determined by the discharge flow rate determination unit. In accordance with such a configuration, in the case that warming up is carried out in a state without a passenger being present in the vehicle, the discharge flow rate of the air pump can be set relatively large. When the discharge flow rate of the air pump is set relatively large, although vibration and noise caused by the air pump become relatively large, since there is no passenger in the vehicle, no sense of discomfort is imparted to the passenger. On the other hand, in the case that warming up is carried out in a state with a passenger being present in the vehicle, the discharge flow rate of the air pump can be set relatively small. Since the discharge flow rate of the air pump is relatively small, vibration and noise caused by the air pump are relatively small, and it is possible to prevent any sense of discomfort from being imparted to the passenger.

The fuel cell system may further include the air conditioning determination unit (70) configured to determine whether or not the air conditioning facility (84) provided in the vehicle is on, wherein the discharge flow rate determination unit may determine the discharge flow rate of the air pump in accordance with the presence or absence of the passenger in the vehicle when air conditioning is performed by the air conditioning facility. In accordance with such a configuration, in the case that air conditioning is carried out in a state without a passenger being present in the vehicle, the discharge flow rate of the air pump is set relatively large. When the discharge flow rate of the air pump is set relatively large, although vibration and noise caused by the air pump become relatively large, since there is no passenger in the vehicle, no sense of discomfort is imparted to the passenger. On the other hand, in the case that air conditioning is carried out in a state with a passenger being present in the vehicle, the discharge flow rate of the air pump is set relatively small. Since the discharge flow rate of the air pump is relatively small, vibration and noise caused by the air pump are relatively small, and it is possible to prevent any sense of discomfort from being imparted to the passenger.

The discharge flow rate determination unit may determine that the discharge flow rate is the first flow rate in the case that the passenger is present in the vehicle, and may determine that the discharge flow rate is the second flow rate which is larger than the first flow rate in the case that the passenger is not present in the vehicle.

The fuel cell system comprises the fuel cell, the air pump configured to supply air to the fuel cell, the main switch determination unit (71) configured to determine the state of the main switch (80) in the vehicle in which the fuel cell and the air pump are installed, the temperature determination unit (67) configured to determine whether or not the temperature detected by the temperature sensor (31) provided in the vehicle is less than a threshold value, the discharge flow rate determination unit configured to determine the discharge flow rate of the air pump when the fuel cell is warmed up, on the basis of the temperature and the state of the main switch, and the control unit configured to control the discharge flow rate of the air pump on the basis of the discharge flow rate determined by the discharge flow rate determination unit. In accordance with such a configuration, in the case that the temperature detected by the temperature sensor provided in the vehicle is less than the threshold value, and warming up is performed in a state with the main switch being turned off, the discharge flow rate of the air pump can be set relatively large. When the discharge flow rate of the air pump is set relatively large, vibration and noise caused by the air pump become relatively large. However, in the case that the temperature detected by the temperature sensor provided in the vehicle is less than the threshold value, and the main switch is turned off, it is considered that a passenger is not present in the vehicle. For this reason, in accordance with such a configuration, it is possible to prevent any sense of discomfort from being imparted to the passenger.

In the case that the temperature is less than the threshold value together with the main switch being turned off, the discharge flow rate determination unit may determine that the discharge flow rate is the second flow rate that is larger than the first flow rate, which is the discharge flow rate of the air pump when the fuel cell is warmed up, without the vehicle being made to travel in a state with the main switch being turned on. In accordance with such a configuration, in the case that the temperature detected by the temperature sensor provided in the vehicle is less than the threshold value, and warming up is performed in a state with the main switch being turned off, the following situation is brought about. More specifically, in such a case, the discharge flow rate of the air pump is set to the second flow rate that is larger than the first flow rate, which is the discharge flow rate at a time of normal warm-up. When the discharge flow rate of the air pump is set to the second flow rate, vibration and noise caused by the air pump become relatively large. However, in the case that the temperature detected by the temperature sensor provided in the vehicle is less than the threshold value, and the main switch is turned off, it is considered that a passenger is not present in the vehicle. For this reason, in accordance with such a configuration, it is possible to prevent any sense of discomfort from being imparted to the passenger.

The threshold value may be a freezing point. In accordance with such a configuration, since warming up is carried out when there is a concern that water generated inside the fuel cell stack may become frozen, it is possible to prevent malfunctioning caused by freezing of the water generated inside the fuel cell stack.

In the control method for the fuel cell system, in which there are included the fuel cell, and the air pump configured to supply air to the fuel cell, the control method comprises the step (step S3) of determining the presence or absence of the passenger in the vehicle in which the fuel cell and the air pump are installed, the step (step S4, step S5) of determining the discharge flow rate of the air pump when the fuel cell is warmed up, in accordance with the presence or absence of the passenger in the vehicle, and the step (step S4, step S5) of controlling the air pump on the basis of the discharge flow rate determined in the step of determining the discharge flow rate.

In the control method for the fuel cell system, in which there are included the fuel cell, and the air pump configured to supply air to the fuel cell, the control method comprises the step (step S11) of determining the state of the main switch in the vehicle in which the fuel cell and the air pump are installed, the step (step S13) of determining whether or not the temperature detected by the temperature sensor provided in the vehicle is less than a threshold value, the step (step S14) of determining the discharge flow rate of the air pump when the fuel cell is warmed up, on the basis of the temperature and the state of the main switch, and the step (step S14) of controlling the discharge flow rate of the air pump on the basis of the discharge flow rate determined in the step of determining the discharge flow rate.

In the non-transitory computer-readable storage medium in which a program is stored, the computer is provided in the fuel cell system that includes the fuel cell and the air pump configured to supply air to the fuel cell. The program serves to execute in the computer the step of determining the presence or absence of the passenger in the vehicle in which the fuel cell and the air pump are installed, the step of determining the discharge flow rate of the air pump when the fuel cell is warmed up, in accordance with the presence or absence of the passenger in the vehicle, and the step of controlling the air pump on the basis of the discharge flow rate determined in the step of determining the discharge flow rate.

In the non-transitory computer-readable storage medium in which a program is stored, the computer is provided in the fuel cell system that includes the fuel cell and the air pump configured to supply air to the fuel cell. The program serves to execute in the computer the step of determining a state of the main switch in the vehicle in which the fuel cell and the air pump are installed, the step of determining whether or not the temperature detected by the temperature sensor provided in the vehicle is less than a threshold value, the step of determining the discharge flow rate of the air pump when the fuel cell is warmed up, on the basis of the temperature and the state of the main switch, and the step of controlling the discharge flow rate of the air pump on the basis of the discharge flow rate determined in the step of determining the discharge flow rate.

What is claimed is:

1. A fuel cell system comprising:
a fuel cell;
an air pump configured to supply air to the fuel cell;
a passenger presence or absence determination unit configured to determine presence or absence of a passenger in a vehicle in which the fuel cell and the air pump are installed;
a discharge flow rate determination unit configured to determine a discharge flow rate of the air pump when the fuel cell is warmed up, in accordance with the presence or absence of the passenger in the vehicle; and
a control unit configured to control the air pump on a basis of the discharge flow rate determined by the discharge flow rate determination unit.

2. The fuel cell system according to claim 1, further comprising:
an air conditioning determination unit configured to determine whether or not an air conditioning facility provided in the vehicle is on;
wherein the discharge flow rate determination unit determines the discharge flow rate of the air pump in accordance with the presence or absence of the passenger in the vehicle when air conditioning is performed by the air conditioning facility.

3. The fuel cell system according to claim 1, wherein the discharge flow rate determination unit determines that the discharge flow rate is a first flow rate in a case that the passenger is present in the vehicle, and determines that the discharge flow rate is a second flow rate which is larger than the first flow rate in a case that the passenger is not present in the vehicle.

4. A fuel cell system comprising:
a fuel cell;
an air pump configured to supply air to the fuel cell;
a main switch determination unit configured to determine a state of a main switch in a vehicle in which the fuel cell and the air pump are installed;
a temperature determination unit configured to determine whether or not a temperature detected by a temperature sensor provided in the vehicle is less than a threshold value;
a discharge flow rate determination unit configured to determine a discharge flow rate of the air pump when the fuel cell is warmed up, on a basis of the temperature and the state of the main switch; and
a control unit configured to control the discharge flow rate of the air pump on a basis of the discharge flow rate determined by the discharge flow rate determination unit.

5. The fuel cell system according to claim 4, wherein, in a case that the temperature is less than the threshold value together with the main switch being turned off, the discharge flow rate determination unit determines that the discharge flow rate is a second flow rate that is larger than a first flow rate, which is the discharge flow rate of the air pump when the fuel cell is warmed up, without the vehicle being made to travel in a state with the main switch being turned on.

6. The fuel cell system according to claim 4, wherein the threshold value is a freezing point.

7. A control method for a fuel cell system including a fuel cell, and an air pump configured to supply air to the fuel cell, the control method comprising:
a step of determining presence or absence of a passenger in a vehicle in which the fuel cell and the air pump are installed;
a step of determining a discharge flow rate of the air pump when the fuel cell is warmed up, in accordance with the presence or absence of the passenger in the vehicle; and
a step of controlling the air pump on a basis of the discharge flow rate determined in the step of determining the discharge flow rate.

8. A control method for a fuel cell system including a fuel cell, and an air pump configured to supply air to the fuel cell, the control method comprising:
a step of determining a state of a main switch in a vehicle in which the fuel cell and the air pump are installed;
a step of determining whether or not a temperature detected by a temperature sensor provided in the vehicle is less than a threshold value;
a step of determining a discharge flow rate of the air pump when the fuel cell is warmed up, on a basis of the temperature and the state of the main switch; and
a step of controlling the discharge flow rate of the air pump on a basis of the discharge flow rate determined in the step of determining the discharge flow rate.

9. A non-transitory computer-readable storage medium in which a program is stored, wherein a computer is provided in a fuel cell system that includes a fuel cell and an air pump configured to supply air to the fuel cell, and the program serves to execute in the computer:
a step of determining the presence or absence of a passenger in a vehicle in which the fuel cell and the air pump are installed;
a step of determining a discharge flow rate of the air pump when the fuel cell is warmed up, in accordance with the presence or absence of the passenger in the vehicle; and
a step of controlling the air pump on a basis of the discharge flow rate determined in the step of determining the discharge flow rate.

10. A non-transitory computer-readable storage medium in which a program is stored, wherein a computer is provided in a fuel cell system that includes a fuel cell and an air pump configured to supply air to the fuel cell, and the program serves to execute in the computer:
a step of determining a state of a main switch in a vehicle in which the fuel cell and the air pump are installed;
a step of determining whether or not a temperature detected by a temperature sensor provided in the vehicle is less than a threshold value;
a step of determining a discharge flow rate of the air pump when the fuel cell is warmed up, on a basis of the temperature and the state of the main switch; and
a step of controlling the discharge flow rate of the air pump on a basis of the discharge flow rate determined in the step of determining the discharge flow rate.
